(19) United States
(12) Patent Application Publication
(10) Pub. No.: US 2012/0069859 A1
(43) Pub. Date: Mar. 22, 2012

(54) LOOP OPTICAL SYSTEM AND ALL-FIBER Q-SWITCHED LASER USING THE SAME

(75) Inventors: Shih-Ting Lin, Tainan City (TW); Tzong-Yow Tsai, Tainan City (TW); Hong-Xi Cao, Tainan City (TW); Chih-Lin Wang, Tainan County (TW)

(73) Assignee: lINDUSTRIAL TECHNOLOGY RESEARCH INSTITUTE, Hsinchu (TW)

(21) Appl. No.: 12/962,661

(22) Filed: Dec. 8, 2010

(30) Foreign Application Priority Data
Sep. 20, 2010 (TW) 99131832

(51) Int. Cl. H01S 3/067; G02B 6/26; G02B 6/35

(52) U.S. Cl. 372/6; 385/16; 385/27

(57) ABSTRACT

An all-fiber Q-switched laser including a laser resonant cavity and a loop optical system is provided. The loop optical system is disposed inside the laser resonant cavity, and the all-fiber Q-switched laser generates a pulsed laser through the loop optical system. The loop optical system includes a plurality of wavelength-division elements and a saturable absorber. One of the wavelength-division elements is coupled with another one of the wavelength-division elements through corresponding first connecting fibers. Two ends of the saturable absorber are respectively coupled to second connecting fibers of the wavelength-division elements, wherein the saturable absorber and the two wavelength-division elements form a loop such that an auxiliary unsaturated light source can be transmitted in the loop.

### CROSS-REFERENCE TO RELATED APPLICATION

This application claims the priority benefit of Taiwan application serial no. 99131832, filed on Sep. 20, 2010. The entirety of the above-mentioned patent application is hereby incorporated by reference herein and made a part of this specification.

### TECHNICAL FIELD

The disclosure relates to a Q-switched laser, and more particularly, to an all-fiber Q-switched laser and a loop optical system thereof.

### BACKGROUND

A Q-switched laser is a pulsed laser, and Q-switching is a technique for generating a pulsed beam. Q-switching techniques are categorized into active Q-switching techniques and passive Q-switching techniques. In a passive Q-switching technique, a saturable absorbing material is placed in a laser resonant cavity, and once the laser is activated, a pulsed beam is automatically generated.

Due to the many advantages of optical fibers, fiber-based pulsed laser has become the focus of development. And the fiber-based pulsed laser techniques need to be further developed to provide a highly stable and low-cost all-fiber Q-switched laser.

### SUMMARY

A loop optical system and an all-fiber Q-switched laser using the same are introduced herein. The disclosure provides a loop optical system adapted to an all-fiber Q-switched laser. The loop optical system includes a plurality of wavelength-division elements and a saturable absorber. Each of the wavelength-division elements includes a first connecting fiber and a second connecting fiber. One of the wavelength-division elements is coupled with another one of the wavelength-division elements through the corresponding first connecting fibers. Two ends of the saturable absorber are respectively coupled to the second connecting fibers of the wavelength-division elements that are coupled with each other through the corresponding first connecting fibers, wherein the saturable absorber and the wavelength-division elements that are coupled with each other through the corresponding first connecting fibers form a loop, so as to generate an auxiliary unsaturated light source.

The disclosure provides an all-fiber Q-switched laser including a laser resonant cavity and the loop optical system mentioned above. The loop optical system is disposed inside the laser resonant cavity, and the all-fiber Q-switched laser generates a pulsed laser through the loop optical system.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a wavelength-division multiplexer and a loop optical system according to an embodiment of the disclosure.

FIG. 2 illustrates an all-fiber Q-switched laser according to an embodiment of the disclosure.

FIG. 3 is an absorption and emission spectrogram of an erbium-doped fiber.

FIG. 4 is a diagram illustrating some levels of erbium ions.

FIG. 5 illustrates signal waveforms of a laser light source generated by an all-fiber Q-switched laser according to an embodiment of the disclosure.

FIG. 6 illustrates all-fiber Q-switched lasers according to other embodiments of the disclosure.

### DETAILED DESCRIPTION

An exemplary embodiment of the disclosure provides a loop optical system. The disclosed loop optical system is a device used for quickly restoring a saturable absorber to an unsaturated state, wherein an auxiliary unsaturated light source is adopted for quickly restoring the saturable absorber back to the unsaturated state so that the performance of a Q-switched laser can be improved and an all-fiber pulsed laser can be achieved.

In following embodiments, an erbium-doped fiber is adopted as an example of the saturable absorber, and those having ordinary knowledge in the art should understand that the erbium-doped fiber is not intended to limit the scope of the saturable absorber in the disclosure.

In addition, the model and type of the wavelength-division elements are not limited in the disclosure, and any optical device that can split a beam can be applied in the disclosure. In correspondence with the erbium-doped fiber, in an exemplary embodiment of the disclosure, 1530/1570 nm wavelength-division multiplexers (WDMs) are adopted as the wavelength-division elements, wherein the 1530/1570 nm WDMs are wavelength-division multiplexers that can transmit light having a wavelength of 1530 nm and reflect light having a wavelength of 1570 nm. However, the disclosure is not limited thereto.

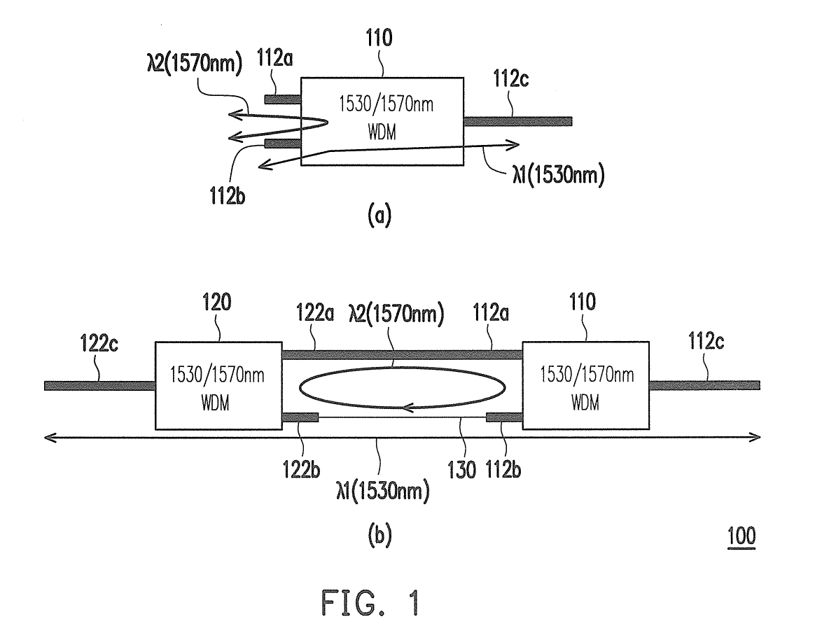

FIG. 1 illustrates a wavelength-division multiplexer and a loop optical system according to an embodiment of the disclosure, wherein FIG. 1(a) illustrates a wavelength-division multiplexer according to an embodiment of the disclosure, and FIG. 1(b) illustrates a loop optical system formed by the wavelength-division multiplexer and a saturable absorber. Referring to FIG. 1, in the present embodiment, the loop optical system 100 includes wavelength-division elements 110 and 120 and a saturable absorber 130. The wavelength-division elements 110 and 120 may respectively be a 1530/1570 nm WDM, and the saturable absorber 130 may be an erbium-doped fiber. However, the disclosure is not limited thereto.

FIG. 1(a) illustrates the wavelength-division element 110 in FIG. 1(b). In the present embodiment, the wavelength-division element 110 includes a first connecting fiber 112a, a second connecting fiber 112b, and a third connecting fiber 112c. The wavelength-division element 110 is adapted to transmit a beam having a first wavelength λ1 and reflect a beam having a second wavelength λ2, as shown in FIG. 1(a). Similarly, the wavelength-division element 120 in the present embodiment has the same or similar technical characteristics as the wavelength-division element 110 therefore will not be described herein.

In the present embodiment, the wavelength-division elements 110 and 120 are coupled with each other through their first connecting fibers 112a and 122a. Besides, two ends of the saturable absorber 130 are respectively coupled to the second connecting fibers 112b and 122b to form the loop optical system 100. In other words, the saturable absorber 130 and the wavelength-division elements 110 and 120 that are coupled with each other through the first connecting fibers 112a and 122a form a loop, so as to generate an auxiliary unsaturated light source (i.e., the beam having the second wavelength λ2).

In the present embodiment, if the loop optical system 100 is applied to an all-fiber Q-switched laser, a laser light source generated by the all-fiber Q-switched laser is a pulsed laser having the first wavelength λ1, and the auxiliary unsaturated light source generated by the loop optical system 100 has the second wavelength λ2. Taking an erbium-doped fiber and the 1530/1570 nm WDMs as example, the first wavelength λ1 may be 1530 nm, and the second wavelength λ2 may be 1570 nm. In other words, in the present embodiment, the first wavelength λ1 of the laser light source generated by the all-fiber Q-switched laser is shorter than the second wavelength λ2 of the auxiliary unsaturated light source generated by the loop optical system 100.

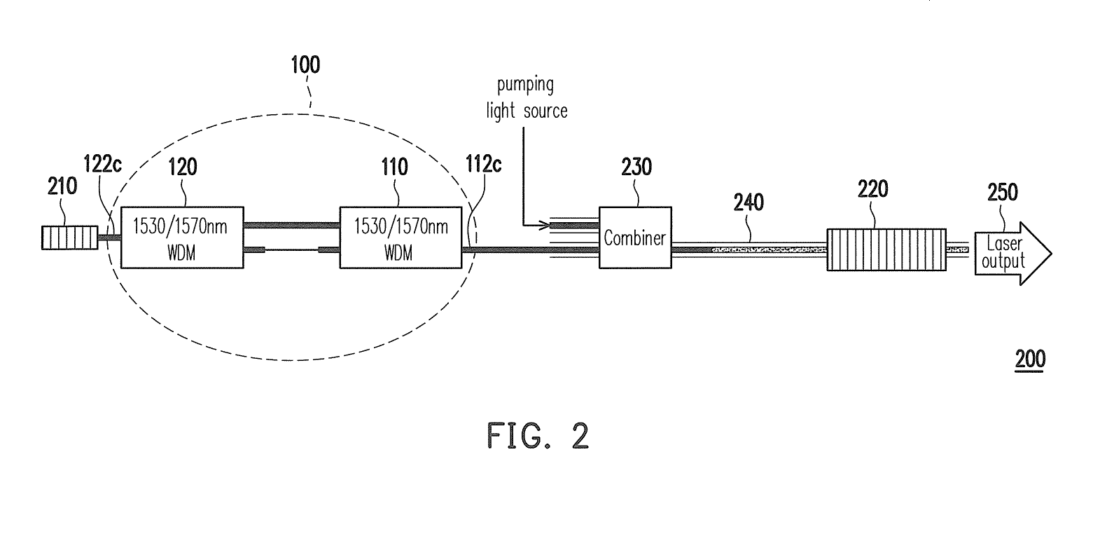

FIG. 2 illustrates an all-fiber Q-switched laser according to an embodiment of the disclosure. Referring to FIG. 1 and FIG. 2, in the present embodiment, the all-fiber Q-switched laser 200 includes a laser resonant cavity constituted by two fiber Bragg gratings (FBGs) 210 and 220, a combiner 230, and the loop optical system 100 illustrated in FIG. 1(b), wherein the loop optical system 100 is disposed inside the laser resonant cavity.

In the present embodiment, the loop optical system 100 is respectively connected to the FBG 210 and the combiner 230 through the third connecting fibers 112c and 122c of the wavelength-division elements 110 and 120, and the combiner 230 is connected to the FBG 220 through a gain fiber 240 (gain fiber), wherein the gain fiber 240 can be used for generating a laser. Thus, when the combiner 230 receives a pumping light source, the gain medium in the gain fiber 240 gains the energy and generates a laser. Herein the FBG 210 is a reflection minor in the laser resonant cavity and can totally reflects a laser beam having the first wavelength 21, and the FBG 220 offers laser beam reflection in a specific proportion of different wavelengths, wherein the remaining proportion of the laser beam is a laser output 250.

In the all-fiber Q-switched laser 200, the optical characteristics of the laser output 250 is determined by the resonant cavity formed by the two FBGs 210 and 220 and a pumping light source. For example, if the pumping light source received by the combiner 230 is the energy generated by a 980 nm laser diode pump, the laser generated by the all-fiber Q-switched laser 200 has a wavelength of 1530 nm.

In addition, the laser energy is accumulated through Q-switching so that the energy consumed by the laser light source inside the resonant cavity can be controlled. Through the energy consumption control, a pulsed laser output 250 is generated at the output end of the all-fiber Q-switched laser 200.

It should be noted that in the present embodiment, the all-fiber Q-switched laser 200 generates a pulsed laser through an all-fiber structure and the loop optical system 100, and the loop optical system 100 allows the auxiliary unsaturated light source (i.e., the beam having the second wavelength λ2) generated by the saturable absorber to be transmitted in a loop structure. Accordingly, the saturable absorber possesses a fast unsaturation characteristic and can be quickly turned off Thereby, the all-fiber Q-switched laser in the present embodiment offers a high stability and a low cost.

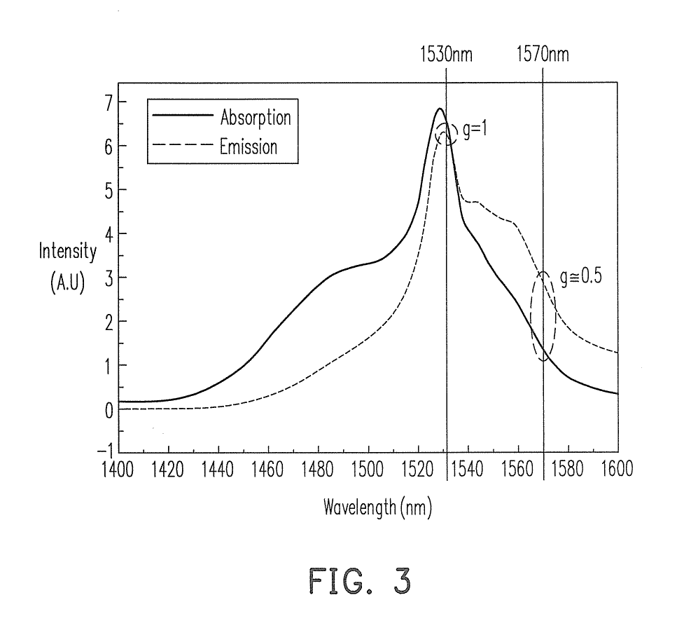

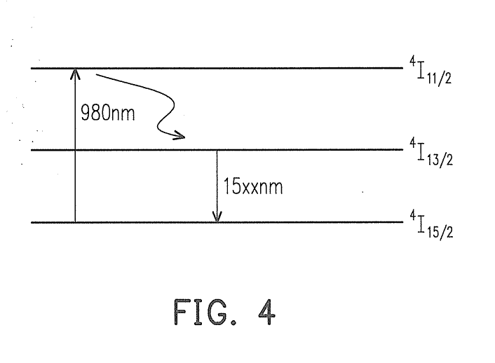

An erbium-doped fiber will be taken as an example of the saturable absorber. FIG. 3 is an absorption and emission spectrogram of the erbium-doped fiber, and FIG. 4 is a diagram illustrating some levels of erbium ions. Referring to FIGS. 1-4, in the present embodiment, the erbium-doped fiber implemented as the saturable absorber 130 absorbs a laser light source having a wavelength of 1530 nm (i.e., the first wavelength λ1) and emits an auxiliary unsaturated light source having a wavelength of 1570 nm (i.e., the second wavelength λ2). Thus, as shown in FIG. 1, in the present embodiment, the laser light source can pass through the resonant cavity freely, while the auxiliary unsaturated light source is trapped within the loop of the optical system 100.

To be specific, after the all-fiber Q-switched laser 200 receives a 980 nm pumping light source, the saturable absorber 130 absorbs the laser light source after a specific duration (for example, several milliseconds) so that the laser light source cannot pass through the loop optical system 100. Then, the saturable absorber 130 quickly reaches a saturated state. After that, the laser light source is allowed to pass through the loop optical system 100 freely so that the all-fiber Q-switched laser 200 generates a pulsed laser having a wavelength of 1530 nm. This process is referred to as a “switch on” step.

Subsequently, when the saturable absorber 130 reaches the saturation state after it absorbs a large quantity of the laser light source, the saturable absorber 130 spontaneously emits light sources of different wavelengths, wherein the light source having the wavelength of 1570 nm is one of the many light sources. Thus, with the system structure provided by the present embodiment, the light source having the wavelength of 1570 nm is trapped within the loop of the optical system 100 as an auxiliary unsaturated light source to help the optical system 100 to generate a pulsed laser having a wavelength of 1530 nm. This process is referred to as an “auxiliary light source generation” step.

In foregoing “switch on” step, the electron number of the laser light source having the wavelength of 1530 nm is indicated as Nₐ₁₅₃₀=(N₁−N₂/g), wherein N₁ and N₂ respectively represent the electron number of erbium ion level ⁴I_{15/2} (will be referred to as a lower energy level electron number N₁ thereinafter) and the electron number of erbium ion level ⁴I_{13/2} (will be referred to as an upper energy level electron number N₂ thereinafter), and g represents a ratio of the absorption value to the emission value in the spectrogram illustrated in FIG. 3. For example, when the wavelength is 1530 nm, the absorption value is equal to the emission value, and accordingly there is g=1.

When the saturable absorber 130 reaches the saturation state after it absorbs a large quantity of the laser light source, the switch is turned on, and because herein Nₐ₁₅₃₀(N₁−N₂/g) is equal to 0, there is N₁/N₂=g=1. In addition, because in the energy level system of the erbium ion, the total of the upper energy level electron number N₂ and the lower energy level electron number N₁ remains unchanged, there is N₁+N₂=N_{T}, wherein N_{T} represents the total electron number. Thus, N₁=N₂=N_{T}/2 can be obtained from foregoing two equations N₁/N₂=g=1 and N₁+N₂=N_{T}.

In foregoing “auxiliary light source generation” step, the electron number of the auxiliary unsaturated light source having the wavelength of 1570 nm is indicated as Nₐ₁₅₇₀=(N₁−N₂/g). In the spectrogram illustrated in FIG. 3, corresponding to the wavelength of 1570 nm, the absorption value is about half of the emission value (i.e., g=0.5). By bringing N₁=N₂=N_{T}/2 and g=0.5 into Nₐ₁₅₇₀=(N₁−N₂/g), Nₐ₁₅₇₀=(N₁−N₂/g)=−N_{T}/2 is obtained, wherein the negative sign indicates that the optical system 100 is in a gain mode for generating a light source (i.e., the auxiliary unsaturated light source having the wavelength of 1570 nm).

On the other hand, when Nₐ₁₅₇₀=(N₁−N₂/g)=0 is obtained after the auxiliary unsaturated light source of 1570 nm is generated, N₁=N_{T}/3 and N₂=2N_{T}/3 are obtained if g=0.5 and N₁+N₂=N_{T} are satisfied. Next, N₁=N_{T}/3 and N₂=2N_{T}/3 are brought into Nₐ₁₅₃₀=(N₁−N₂/g) to obtain Nₐ₁₅₃₀=(N₁−N₂/g)=N_{T}/3. It should be noted that the current value of Nₐ₁₅₃₀ is not 0 but is a positive value, which means the system switch is not turned on but is in a light source absorbing state. In other words, presently the saturable absorber 130 enters an unsaturated state again to absorb the laser light source. This process is referred to as a “switch off” step.

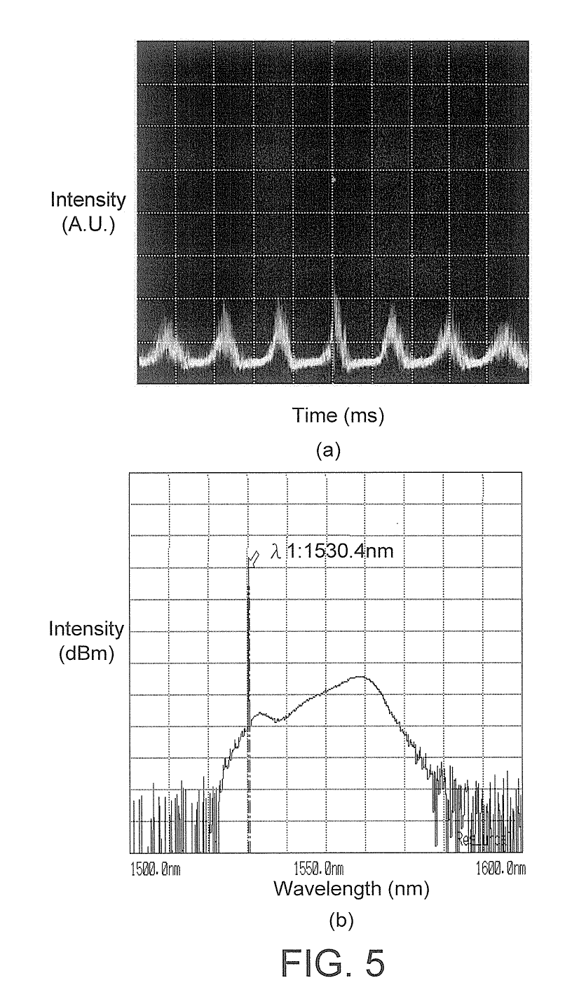

In other words, after the all-fiber Q-switched laser 200 receives the pumping light source of 980 nm, in the loop optical system 100, aforementioned “switch on” step, “auxiliary light source generation” step, and “switch off” step are repeatedly carried out so that the all-fiber Q-switched laser 200 can generate a continuous pulsed laser having the wavelength of 1530 nm, as shown in FIG. 5.

It should be noted that in the level system of a substance, a single level is usually expanded into a plurality of sub levels. For example, in the level system of an erbium ion, the upper energy level ⁴I_{15/2} and the lower energy level ⁴I_{13/2} are usually expanded into a plurality of sub levels (not shown) from a physical point of view. Thus, in FIG. 4, the multi-wavelength light source spontaneously emitted by electrons falling from the upper energy level ⁴I_{15/2} of erbium ions to the lower energy level ⁴I_{13/2} thereof can be expressed as 15XX nm. This expression indicates that a laser light source having a wavelength of 1530 nm has the same upper energy level electron number N₁ and the same lower energy level electron number N₂ as the auxiliary unsaturated light source having the wavelength of 1570 nm.

In other words, in the present embodiment, the laser light source and the auxiliary unsaturated light source of the loop optical system 100 have to have the same upper energy level electron number and the same lower energy level electron number in order to carry out the “switch on” step, the “auxiliary light source generation” step, and the “switch off” step.

FIG. 5 illustrates signal waveforms of a laser light source generated by an all-fiber Q-switched laser according to an embodiment of the disclosure. Referring to FIG. 5, a continuous pulsed laser generated by the all-fiber Q-switched laser through the loop optical system 100 and repeated execution of the “switch on” step, the “auxiliary light source generation” step, and the “switch off” step is illustrated in FIG. 5(a), and the signal waveform of one of such continuous pulsed lasers is illustrated in FIG. 5(b).

As shown in FIG. 5, the all-fiber Q-switched laser in the present embodiment generates a laser light source having a wavelength of 1530 nm and offers very good optical characteristics. In addition, due to the auxiliary unsaturated light source generated by the loop optical system 100, the saturable absorber can be quickly unsaturated so that an instant turnoff function can be accomplished.

Generally speaking, the material of the saturable absorber has to satisfy one condition, which is, the absorption cross section (σₐ) of the saturable absorbing material has to be greater than the stimulated emission cross section (σ_{g}) of the gain medium (i.e., σₐ/σ_{g}>1). Besides, a greater ratio between the two values (σₐ/σ_{g}) brings a higher efficiency in the saturable absorber Q-switch. In an exemplary embodiment of the disclosure, by increasing the ratio of the core area A_{g} of the gain fiber to the core area Aₐ of the saturable absorbing fiber, the condition can be adjusted into:

$$\frac{{σ}_{a} {A}_{g}}{{σ}_{g} {A}_{a}} > 1$$

Because the laser light source is transmitted within the fiber core of a fiber, the intensity of a light beam within the core of a gain fiber can be reduced by increasing A_{g}. Contrarily, the intensity of a light beam within the core of a saturable absorbing fiber can be increased by decreasing A_{g}. Thus, the saturable absorbing fiber can quickly reach a saturated state and generate a pulsed laser. If the absorption cross section σₐ of the saturable absorbing material is smaller than the stimulated emission cross section σ_{g} of the gain medium, in an exemplary embodiment of the disclosure, the all-fiber Q-switched laser can be made to satisfy foregoing adjusted condition by increasing the ratio of the core area A_{g} of the gain fiber to the core area Aₐ of the saturable absorbing fiber. Thereby, in an exemplary embodiment of the disclosure, the same material can be served as both the saturable absorber and the gain medium, so that the problem of material shortage can be resolved.

In order to achieve aforementioned purpose, in the loop optical system 100 illustrated in FIG. 1, when the saturable absorber 130 is implemented with a saturable absorbing fiber, the core area or diameter of the saturable absorbing fiber may be designed to be smaller than the core area or diameter of the second connecting fibers 112b and 122b, and when the third connecting fibers 112c and 122c are connected to the gain fiber 240, the core area or diameter of the gain fiber 240 may be designed to be greater than the core area or diameter of the third connecting fibers 112c and 122c. For example, the core diameter of the saturable absorber 130 may be designed to be between 3 μm and 20 μm, the core diameter of the second connecting fibers 112b and 122b may be designed to be between 3 μm and 30 μm, and the core diameter of the gain fiber may be designed to be between 5 μm and 30 μm.

In addition, in the loop optical system 100 illustrated in FIG. 1, the core areas or diameters of the first connecting fibers 112a and 122a, the second connecting fibers 112b and 122b, and the third connecting fibers 112c and 122c may be designed to be the same, and the fibers in the system may be connected through fusion splice, optical alignment, or other techniques. However the fibers are connected is determined according to system requirement.

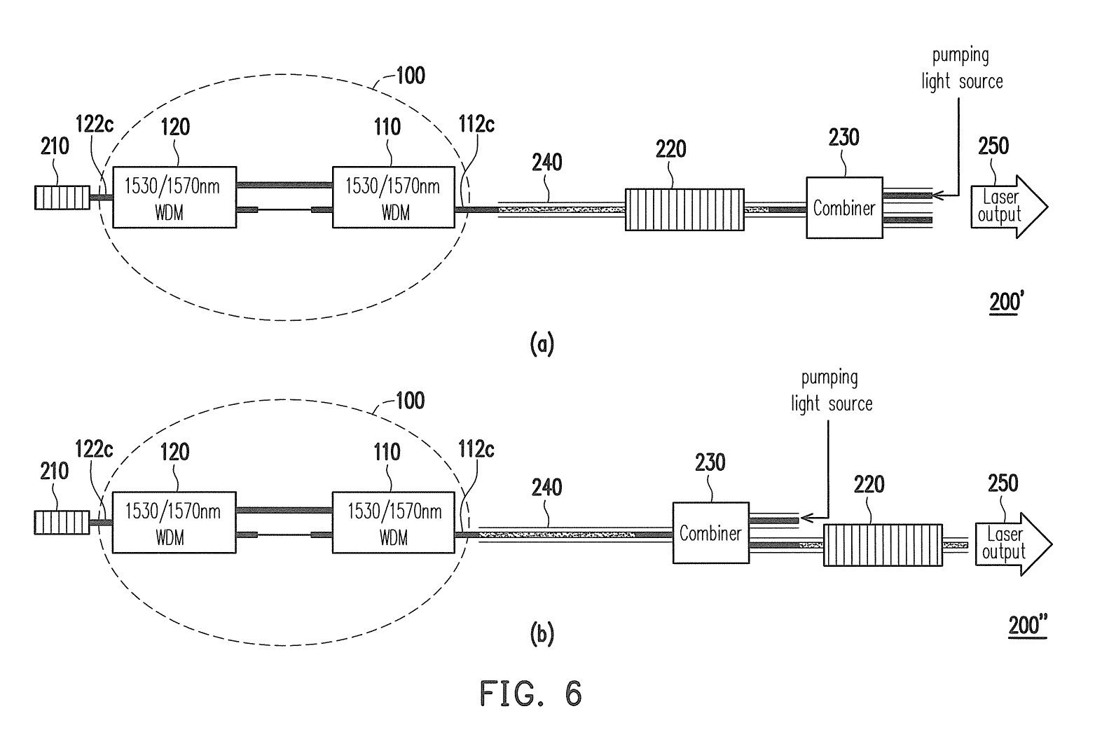

Additionally, in an exemplary embodiment of the disclosure, the all-fiber Q-switched laser is not limited to the structure illustrated in FIG. 2. FIG. 6 illustrates all-fiber Q-switched lasers according to other embodiments of the disclosure. Both the all-fiber Q-switched lasers 200′ and 200″ in FIG. 6 can generate continuous pulsed lasers having the wavelength of 1530 nm, and through the loop optical system 100, the saturable absorber can quickly resume an unsaturated state to accomplish an instant turnoff function. Those same or similar aspects will not be described herein again. In addition, the loop optical system 100 illustrated in FIG. 1 can be applied to a laser system within the wavelength range of 1020 nm-1600 nm. However, the disclosure is not limited thereto.

In summary, in the exemplary embodiment of the disclosure, the all-fiber Q-switched laser transmits an auxiliary unsaturated light source generated by a saturable absorber in a loop structure of a loop optical system, and because the auxiliary unsaturated light source has the same upper and lower energy level electron numbers as the laser, the saturable absorber can quickly resume an unsaturated state, so that an instant turn-off function is accomplished.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A loop optical system, which is used to generate an auxiliary unsaturated light source, the loop optical system comprising:
a plurality of wavelength-division elements, wherein each of the wavelength-division elements comprises a first connecting fiber and a second connecting fiber, and one of the wavelength-division elements is coupled with another one of the wavelength-division elements through the corresponding first connecting fibers; and
a saturable absorber, wherein two ends of the saturable absorber are respectively coupled to the second connecting fibers of the wavelength-division elements that are coupled with each other through the corresponding first connecting fibers,
wherein the saturable absorber and the wavelength-division elements that are coupled with each other through the corresponding first connecting fibers form a loop.

2. The loop optical system according to claim 1, wherein the wavelength-division elements comprise:
a first wavelength-division element;
a second wavelength-division element, wherein the first connecting fiber of the second wavelength-division element is coupled to the first connecting fiber of the first wavelength-division element,
wherein the two ends of the saturable absorber are respectively coupled to the second connecting fiber of the first wavelength-division element and the second connecting fiber of the second wavelength-division element.

3. The loop optical system according to claim 1, wherein the wavelength-division elements are adapted to transmit a beam having a first wavelength and reflect a beam having a second wavelength, wherein the auxiliary unsaturated light source has the second wavelength.

4. The loop optical system according to claim 3, wherein an energy level system of the saturable absorber has an upper energy level and a lower energy level, and the auxiliary unsaturated light source is generated when electrons fall from the upper energy level to the lower energy level.

5. The loop optical system according to claim 3, wherein the saturable absorber emits the auxiliary unsaturated light source.

6. The loop optical system according to claim 1, wherein the saturable absorber is a saturable absorbing fiber, and a core area or diameter of the saturable absorbing fiber is smaller than a core area or diameter of the second connecting fiber.

7. The loop optical system according to claim 7, wherein a core diameter of the saturable absorber is between 3 μm and 20 μm.

8. The loop optical system according to claim 7, wherein a core diameter of the second connecting fiber is between 3 μm and 30 μm.

9. The loop optical system according to claim 1, wherein the saturable absorber is a saturable absorbing fiber, and a core diameter of the saturable absorbing fiber is between 3 μm and 30 μm.

10. The loop optical system according to claim 1, wherein core areas or diameters of the first connecting fiber and the second connecting fiber are the same.

11. The loop optical system according to claim 1, wherein the saturable absorber is a saturable absorbing fiber, and the first connecting fiber, the second connecting fiber, and the saturable absorbing fiber are connected through fusion splice or optical alignment.

12. The loop optical system according to claim 1, wherein the saturable absorber is an erbium-doped fiber.

13. The loop optical system according to claim 1, wherein the wavelength-division elements are wavelength-division multiplexers.

14. The loop optical system according to claim 1, wherein the loop optical system is adapted to a laser system having a wavelength range of 1020 nm to 1600 nm.

15. An all-fiber Q-switched laser, comprising:
a laser resonant cavity; and
a loop optical system as claimed in claim 1, disposed inside the laser resonant cavity, wherein the all-fiber Q-switched laser generates a pulsed laser through the loop optical system.

16. The all-fiber Q-switched laser according to claim 15, wherein the wavelength-division elements in the loop optical system are adapted to transmit a beam having a first wavelength and reflect a beam having a second wavelength, wherein a laser light source generated by the all-fiber Q-switched laser has the first wavelength, and the auxiliary unsaturated light source has the second wavelength.

17. The all-fiber Q-switched laser according to claim 15, wherein an energy level system of the saturable absorber in the loop optical system has an upper energy level and a lower energy level, and the laser light source and the auxiliary unsaturated light source are generated when electrons fall from the upper energy level to the lower energy level, wherein the laser light source and the auxiliary unsaturated light source have a same upper energy level electron number and a same lower energy level electron number.

18. The all-fiber Q-switched laser according to claim 16, wherein the first wavelength of the laser light source is shorter than the second wavelength of the auxiliary unsaturated light source.

19. The loop optical system according to claim 15, wherein the saturable absorber absorbs the laser light source and emits the auxiliary unsaturated light source.

20. The all-fiber Q-switched laser according to claim 15, wherein each of the wavelength-division elements further comprises a third connecting fiber, and the third connecting fiber is adapted to be coupled to a gain fiber in the all-fiber Q-switched laser.

21. The all-fiber Q-switched laser according to claim 20, wherein a core area or diameter of the gain fiber is greater than a core area or diameter of the third connecting fiber.

22. The all-fiber Q-switched laser according to claim 21, wherein core diameter of the gain fiber is between 5 μm and 30 μm.

23. The all-fiber Q-switched laser according to claim 21, wherein the saturable absorber in the loop optical system is a saturable absorbing fiber, and a core diameter of the saturable absorbing fiber is between 3 μm and 30 μm.

24. The loop optical system according to claim 20, wherein core areas or diameters of the first connecting fiber, the second connecting fiber, and the third connecting fiber are the same.

25. The loop optical system according to claim 20, wherein the saturable absorber in the loop optical system is a saturable absorbing fiber, and the first connecting fiber, the second connecting fiber, the third connecting fiber, the gain fiber, and the saturable absorbing fiber are connected through fusion splice or optical alignment.
